(19) United States
(12) Patent Application Publication
(10) Pub. No.: US 2002/0087448 A1
(43) Pub. Date: Jul. 4, 2002

(54) Intellectual property commercialization method

(76) Inventor: William T. Wilkinson, Salem, NJ (US)

Correspondence Address: RATNER & PRESTIA, P.O. BOX 7228, WILMINGTON, DE, 19803, US

(21) Appl. No.: 10/007,205

(22) Filed: Nov. 9, 2001

Related U.S. Application Data
(60) Provisional application No. 60/246,944, filed on Nov. 9, 2000.

(51) Int. Cl. G06F 17/60

(52) U.S. Cl. 705/36

(57) ABSTRACT

A method for commercialization of intellectual property (IP) comprising the steps of providing a comprehensive, centralized network of service provider members, each member having expertise in at least one facet of IP commercialization, offering an interested party access to the network, such as by computer, telephone, or attendance at a network event, and one or more network members providing services to the interested party. The method may comprise creating a financial market for IP assets where IP assets, or securities based upon IP assets, can be bought and sold. The method may comprise providing a certification program for certifying IP analysts qualified to provide tangible valuation of IP assets. One aspect of the invention may comprise providing a trade show in which the service providers are grouped in a physical layout by a corresponding step in an IP asset life cycle.

### CROSS-REFERENCE TO RELATED APPLICATIONS

This application claims priority based upon U.S. Provisional Patent Application Serial No.60/246,944, filed Nov. 9, 2000.

### TECHNICAL FIELD

The present invention relates generally to intellectual property and, more specifically, to a method for commercializing intellectual property.

### BACKGROUND OF THE INVENTION

Increasingly, Intellectual Property (IP) assets are becoming more important and valuable to business. They are unique assets that have heretofore been classified as intangible, but are now being recognized as having a more tangible or real value.

There are currently a number of organizations representing the interests of various groups that deal in the business of IP, such as inventors, copyright holders, licensing executives, lawyers, and the like. With its increasing importance, however, IP is now emerging as a distinct, major industry having many facets, each facet in need of services to address its individual needs. Although various service providers exist who are integral to the IP commercialization process, these service providers generally must be sought out individually by someone trying to commercialize IP. Especially for the uninitiated in the process of developing IP, the process of seeking such individual service providers may be time-consuming and arduous. Time is often of the essence in commercializing IP, so any method by which the commercialization process can be accelerated, enhanced, or simplified, is of great importance to the progress of innovation overall.

Although there are many organizations that specialize in providing information to various groups with interests in specific aspects of intellectual property, such as but not limited to the Intellectual Property Owners Association, and the Licensing Executives Society, such organizations tend to be issue-oriented and limited in scope. Periodic meetings and trade shows of such organizations tend to focus on the particular aspects of interest to the respective organization. There remains no central organization dedicated to bringing together all facets of intellectual property or that addresses all the steps relevant to the commercialization of intellectual property.

Thus, there is an increasing need for a method that brings together all of the participants in the growing IP business in a centralized location, to better commercialize IP, by promoting trade/commerce among the various members and businesses that are related to or dependent upon IP.

### SUMMARY OF THE INVENTION

One aspect of the invention comprises a method for commercialization of intellectual property (IP). The method comprises the step of providing a comprehensive, centralized network of service provider members, each member having expertise in at least one facet of IP commercialization. The method then comprises the steps of offering an interested party access to the network, such as by computer, telephone, or attendance at a network event, and one or more network members providing services to the interested party. Where the interested party has an interest in receiving information, data, or a combination thereof regarding at least one aspect of IP, the method may further comprise the steps of collecting data relating to at least the one aspect of IP, and disseminating the data to at least the interested party. The information may comprise analytic information identifying, classifying, comparing, ranking and evaluating one or more IP assets, entities that own or control IP, or sources of IP, in which case the method further comprises compiling said analytic information.

Another aspect of the method may comprise creating a financial market for IP assets where IP assets, or securities based upon IP assets, can be bought, licensed, hypothecated, and sold. Yet another aspect of the method may comprise providing a certification program for certifying IP analysts qualified to provide tangible valuation of IP assets and analysis of the impact of IP on security prices, including an educational program comprising education in accounting, financial, legal, and actuarial skills for educating individuals how to provide tangible valuation of IP assets and securities analysis based upon IP holdings.

A still further aspect of the invention may comprise organizing a trade show in which a comprehensive network of service providers exhibit information to others, each service provider having expertise corresponding to at least one step in a natural life cycle of an IP asset, in which the service providers are grouped in a physical layout at the trade show by their corresponding step in the IP asset life cycle. The service providers may be grouped into legal service providers, business service providers, pre-market service providers, commercialization service providers, and after-market service providers.

A computerized aspect of the invention may comprise the steps of providing a dedicated site on the global computer network accessible by the interested party; providing computerized means for digitally receiving a request for information about one or more service provider members from the interested party; providing a database of records relating to the service provider members searchable by the computerized means in response to the request for information; and providing the requested information to the interested party.

### BRIEF DESCRIPTION OF DRAWINGS

FIG. 1 is a flowchart of an exemplary method in accordance with the present invention.

FIG. 2 is a schematic drawing an exemplary trade show layout in accordance with the invention.

### DETAILED DESCRIPTION OF INVENTION

The invention will next be illustrated with reference to the figure, which is intended to be illustrative rather than limiting, and is included herewith to facilitate the explanation of the present invention.

This invention comprises a comprehensive IP commercialization method having a number of interrelated sub-methods. In a preferred form, the method comprises formation of a comprehensive, centralized industry trade group or association (step 10), which is essentially a comprehensive network of service providers, each provider having expertise in at least one facet of IP commercialization. This method may accelerate the process of taking an idea from conception to being a marketplace product, and may comprise services that improve research and development processes generally.

The evolution of a concept into a marketplace product typically may include any or all of the following stages of development: concept generation, sketching or flowcharting, prototype manufacturing, pursuing and securing IP rights (filing for patents, copyrights, or trademarks, or deciding to keep as a trade secret), testing, pre-production prototype manufacturing, licensing, commercial product manufacturing, pricing, market testing, advertising and marketing, sale and distribution of the product, and sale of the product business.

The commercialization method comprises providing a comprehensive, centralized network of service providers, each having expertise in at least one aspect of IP commercialization, such as expertise in one of the stages of development noted above. The method comprises offering an interested party access to the network and the network providing services to the interested party. The consideration provided by the interested party for access to the network may be in the form of a flat fee, a fee per services rendered, and/or a percentage of royalties, stock, or other interest in the IP asset or business which holds the IP asset. The interested party may also be a member of the network, for which membership in the network may be considered adequate consideration for receiving the services provided by the network. The members of the network may provide services in exchange for a fee to be paid by the network organizer, and/or for a fee from the interested party directly. The members of the network may become part of the network by paying a referral fee to the network organizer per matter sent to the member, paying a membership fee on a regular basis, such as annually (as indicated in step 12), or by agreeing to provide services at a fixed fee to interested parties referred by the network.

“Comprehensive” as used herein means that the network comprises as members essentially at least one of every type of service provider essential to evolve an IP asset from conception to the marketplace. For example, such a comprehensive network may comprise legal service providers, business service providers, pre-market service providers, commercialization service providers, and after-market service providers, all of which are discussed in more detail below. Preferably at least one of every conceivable type of service provider that might be needed to evolve the IP asset from conception to marketplace may be included in the network.

“Centralized” means the network provides access to all the various members of the network through one or more access points. Thus, for example, rather than an inventor having to search the yellow pages, the Internet, or various trade publications to individually find the various service providers needed to bring his invention to market, the inventor may be able to find all of the service providers by consulting a single access mechanism. The access mechanism may comprise any mechanism of providing information known in the art, for example but not limited to, an Internet website, a trade show, a physical office for the trade association, or a publication listing the members and their services.

The comprehensive network may perform one or more, preferably all, of the functions discussed below. The commercialization method includes promotion of IP business between one or more of the members of the network, including business-to-business and business-to-consumer promotion. The network may, for example, conduct seminars, hold periodic (such as annual) trade shows, and/or conduct a periodic (such as annual) awards program, as indicated in step 14. In general, however, the network may do any number of things to promote businesses and services that improve the IP commercialization process, as indicated in step 16.

The network may serve as a governing body for the IP industry and a representative body to the Government and the public. For example, in step 30, the method may comprise developing an IP policy or program. Such policies and programs may be developed through general and committee meetings of the members of the network, by voting of the members of the network, or any other means known in the art. The policies and programs may then be presented in step 32 through lobbying or other interfacing with regulators and professional groups, such as but not limited to, Congress, the US Patent & Trademark Office (PTO), the Securities and Exchange Commission (SEC), and the Financial Accounting Standards Board (FASB), for example.

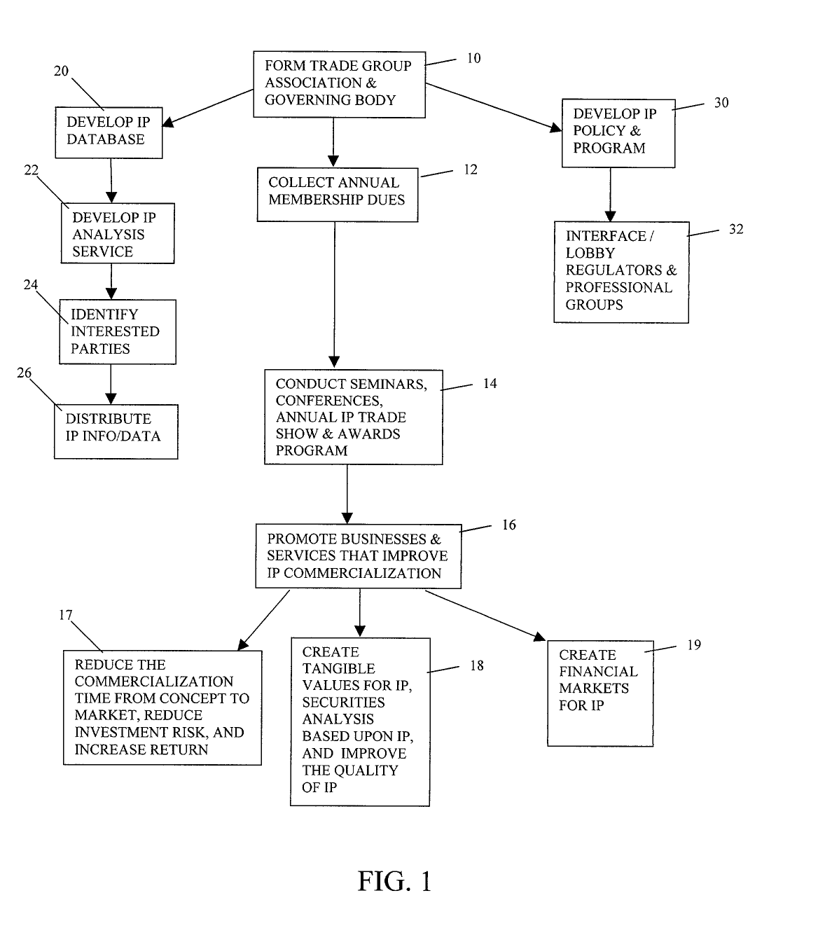

The network also may serve as a central depository and exchange for IP data and services, and provide a means to disseminate IP information to various interested parties, thereby improving communication about IP, as outlined in steps 20-26 in FIG. 1. For example, the network may develop an IP database (step 20) of inventors, inventive entities, and the IP assets associated with those inventors and entities. Using that database, an analytic service may be provided to identify, classify, compare, rank, and evaluate IP assets, inventors, and/or inventive entities (step 22). The method may further comprise identifying interested parties, such as governmental bodies, corporate or business entities, educational institutions such as universities, foundations, and individuals, who may want the analytic information provided by this service, as indicated in step 24. Then, the method may comprise in step 26, distributing IP information and data to the interested parties through various means. Such means may include, but are not limited to newsletters, websites, conferences, seminars, press coverage, such as in newspapers and the like, and magazines. Other means are listed herein later.

Among the services offered by service providers in the network may be services that create tangible values for IP, services that create financial statements, services that provide lending, collateral, and/or equity investment, services that provide R&D project analysis and/or evaluation, licensing services, insurance services, legal services including litigation services, security analysis (analysis of a stock or other security based upon the IP held by the entity for which the security corresponds), management consulting, and the like. Thus, the network may promote the tangible valuation of IP and improve the quality of IP. For example, the network may offer services such as prior art searches, IP asset valuation services and audit services. One method of conducting an IP audit is disclosed in the U.S. Patent Application titled METHOD FOR AUDITING INTELLECTUAL PROPERTY, filed Oct. 11, 2001, claiming priority from U.S. Provisional Patent Application Serial No. 60/240,135, filed on Oct. 13, 2000, by the common inventor of the present invention, and incorporated herein by reference.

The network may also provide services in the nature of IP securitization and creating IP financial markets, such as a central marketplace for IP, that improve trade/commerce in the IP Industry, as indicated in step 19. A method for IP securitization and creating IP financial markets is further described in U.S. patent application Ser. No.: 09/797,930, filed Mar. 2, 2001, titled INTELLECTUAL PROPERTY FINANCIAL MARKETS METHOD AND SYSTEM, claiming priority from U.S. Provisional Application Serial No. 60/186,547, filed Mar. 2, 2000, by the common inventor of this invention and incorporated herein by reference.

Such financial markets may include auctions or exchanges that determine the fair market value of the IP assets. Additionally, IP insurance may be provided related to the tangible value of the IP asset. An exemplary method for providing IP insurance is described in the U.S. Patent Application filed Oct. 18, 2001, titled METHOD OF PROVIDING INSURANCE FOR INTELLECTUAL PROPERTY, claiming priority from U.S. Provisional Application Serial No. 60/242,307, filed Oct. 20, 2000, by the common inventor of this invention, and incorporated herein by reference. In addition, the creation of financial markets may comprise creating debt markets and securities for IP assets.

The assignment of tangible value for IP assets may be used to encourage IP investment. A method for assigning tangible value to IP assets is further described in U.S. patent application Ser. No. 09/593,576, filed Jun. 14, 2000, titled INTELLECTUAL PROPERTY VALUATION PROCESS, claiming priority from U.S. Provisional Application Serial No. 60/139,247, filed Jun. 15, 1999, by the common inventor of this invention, both of which are incorporated herein by reference.

A method for IP investment management is the subject of U.S. patent application Ser. No. 09/915,685, filed Jul. 26, 2001, titled INTELLECTUAL PROPERTY INVESTMENT PROCESS, claiming priority from U.S. Provisional Application Serial No. 60/220,873, filed Jul. 26, 2000, by the common inventor of this invention and incorporated herein by reference. Such investments may range from using IP assets for collateral for bank loans to developing equity markets, securities, or funds featuring IP assets. Such IP funds may adjust the value/risk of securities to reflect IP valuation and risk. Thus, the creation of financial markets for IP may promote the flow of IP and/or products to capital and/or financial sources, and vice versa.

The network discussed herein has many benefits and advantages. For example, such a network may encourage the generation or more ideas and IP, generally, as well as improving the quality and relevance of ideas and IP that are generated. Most advantageously, however, the network may improve the speed at which a concept or idea develops into a marketable product, as indicated in step 17. By providing access to the comprehensive collective members of the network, the commercialization method provides, particularly to individual inventors or others without extensive experience in IP commercialization, one-stop shopping to get all of the various services needed to bring an idea to market. The network may therefore reduce R&D development expense, reduce R&D risk, and improve the return on R&D by providing specialists in the various aspects of commercialization. This is particularly desirable in light of some estimates showing that only 5% of R&D projects ultimately yield any return or income. A method for improvement of R&D processes is further described in U.S. patent application Ser. No. 09/771,286, filed Jan. 26, 2001, titled IMPROVED RESEARCH AND DEVELOPMENT PROCESS, claiming priority from U.S. Provisional Application Serial No. 60/178,677, filed Jan. 28, 2000, by the common inventor of this invention and incorporated herein by reference.

The creation of an insurance market and debt and equity markets for IP also allows risk spreading and improves access to capital and funding for IP, inventors and R&D projects. By providing an IP incentive/award system, the network may promote creativity and innovation in many different fields. By providing lobbying, the network may help to effect IP legislation that favors faster commercialization, better protection of IP assets, and provides greater incentives for innovation.

The members of the network may include one or more IP interest groups/service providers that generally fall within a number of broad categories, including but not limited to: inventors, government entities, research and development (R&D) and manufacturing entities, IP specialists, providers of business services, and IP marketplace providers. The general category of inventors may include, but is not limited to: individual inventors, corporate inventors, corporate R&D managers/directors, government inventors, university inventors, private institution/foundation inventors, and inventor associations. The government entities may include, but are not limited to the Patent and Trademark Office (PTO), the Library of Congress/Copyright Office, the Securities and Exchange Commission (SEC), and other governmental agencies. R&D and manufacturing entities may include, but are not limited to: prototype/sample makers, industrial designers, draftspersons, test laboratories, and manufacturers. IP specialist service providers may include, but are not limited to: innovation/patent ranking services, patent or trademark search services, IP attorneys, and other patent, trademark, copyright, and trade secret specialists. Business services providers may comprise any providers of business services that may be useful for developing or commercializing a new business, such as: accountants such as certified public accountants (CPAs), actuaries, insurance companies, fund managers, appraisers, business plan preparers, banks, brokers, investors such as venture capitalists, investment managers/advisors, mutual fund managers, investment bankers, securities analysts, business consultants, corporate executives, and specialists in various areas, such as software, specific industries, and marketing/advertising. IP marketplace providers may provide various marketplaces for IP, such as exchanges or auctions.

The IP commercialization method comprises a number of sub-methods that can be incorporated or practiced by various service providers that are part of the larger trade association. Among these sub-methods may be a method for aggregating and disseminating various types of IP data to interested parties. As indicated in steps 20-26, such method may comprise identifying at least one interested party having an interest in receiving information and/or data regarding at least one aspect of IP, collecting IP data relating to at least the one aspect of IP, and disseminating that data to at least the interested party. The steps of this sub-method do not necessarily have to be performed in any order, and may include additional steps or sub-steps.

The method can be practiced or focused to deal with any territory or country, but preferably is international in scope. The method can employ or utilize any means to promote the members and services of the network, including but not limited to one or more of the following: membership associations, trade shows, conferences, seminars, awards programs and/or shows, newsletters, internet websites, subscription services, direct mail, catalogues, directories, magazines, books, video tapes, interactive computer programs provided on storage media such as CDs, audio recordings, radio and TV advertisements, advertorials, and/or infomercials, televised shopping, direct solicitation, and telemarketing.

One service provided by the network may be an analytic service that identifies, classifies, compares, ranks and evaluates IP and entities that own and/or control IP. Such service can also be used to identify, classify, and rank innovation and the sources of innovation and creativity, such as inventors and R&D programs. IP, inventors, and R&D programs can be identified, classified, compared, ranked, and evaluated based upon any number of criteria. One such criteria may include the type of IP (such as patent, trade secret, copyright, trademark, or domain names). Other criteria may include the type of property interest in the IP (whether the entity is an assignee or assignor, licensee or licensor, owner, inventor, author, or publisher, for example) and the nature of the subject matter (such as software, articles of manufacture, goods, services, processes, chemical compounds, literary works, sound recordings, motion pictures, and the like). Other criteria may include both the quantity of IP (such as the number of IP holdings or licenses) and the quality of the IP (such as the age of the IP, number of years remaining in life, validity based on a prior art search, or new potential markets identified). The total value of the IP (gross revenues from IP), as well as the total IP expenses, total IP investment (such as R&D expense and IP acquisition investment), and return on investment (net profit after gross business expenses divided by total IP investment) may also be taken into account. The location of the IP (for example, the geographic region such as country or state, or industry sector within which the IP is used) may also be considered, as may be the risk associated with one or more IP assets specifically, the general IP categories, or the IP owner or other entity.

The analytic service disclosed herein may be used for many purposes, such as for example, identifying innovation and creativity and/or providing the basis for an innovation awards or incentive program. The analytic information may provide relevant information regarding inventors and inventive entities that may be useful in making personnel decisions, such as by R&D managers. The information may also be used to evaluate R&D programs, value IP and R&D holdings, value the entity that owns the IP (a corporation's stock or individual's worth, for example), to determining the risk and return associated with a particular IP holding, and/or to identify and evaluate potential IP investments.

A number of users may benefit from the methods described herein, including without limitation, inventors, investors, and financial entities who may want to invest in IP, buy and sell IP, or analyze the impact of IP on specific businesses and/or industries. The method may be particularly advantageous for inventors, however, especially individual inventors or inventive entities without substantial IP experience or infrastructure. For an inventor wanting to commercialize his or her invention using the method of this invention, the inventor may first conceive an idea that can be protected as an IP asset. Although discussed in terms of “inventions” herein, the idea may be capable of being protected by any type of IP, such as without limitation, patent, trademark, copyright, or trade secret. The inventor can then contact the network and become a member or otherwise provide consideration for being permitted access to the network. The inventor then typically may have an extensive prior art search performed by a member of the network. The prior art search may be used to determine patentability (or use and registerability of a trademark, for example), as well as a mechanism for identifying potential markets for the new idea. The inventor may confer with other members of the network to assist in fully defining the idea and its market potential. Then, the inventor may utilize a legal services provider member of the network to secure his or her intellectual property rights by filing one or more patent applications, trademark applications, or copyright applications, or by defining a program for protecting the idea as a trade secret.

Next, the inventor may have his or her IP valued, for example, for the purposes of securing a loan using the IP as collateral. The inventor may meet with a number of financial services members, such as banks, venture capitalists, or private equity sources willing to help finance the commercialization process. As part of presenting the idea to secure such funding, the inventor may take advantage of other business services provider members of the network, such as business plan consultants who can help develop business plans or accountants who can help forecast the budget for the commercialization process. Next, the inventor may need the services of a prototype or model maker member of the network who can build initial prototypes. Furthermore, the inventor may seek the assistance of an engineering services provider member of the network to streamline the product for manufacture or make sure the product is structurally sound. The inventor may then conduct product testing using test lab service provider members or market testing service provider members to perfect the product for market. The inventor may also seek the services of industrial design members and/or commercial artist members to maximize the product's commercial appeal.

As the product nears the marketplace, the inventor may then need further consultation with legal services provider members of the network to help negotiate licenses or contracts with potential manufacturers, distributors, and/or retailers. Manufacturer members of the network may be used for sourcing materials or producing the product. Marketing and advertising specialist members of the network may be consulted for providing a marketing strategy and advertising copy to be used to sell the product.

In the latter stages of the business cycle for the concept, legal services may again be required to handle litigation related to the IP or other aspects of the business. Financial service providers and legal service providers in the network may be consulted to help coordinate an Initial Public Offering (IPO) or a sale of the business or IP asset. In either case, the inventor may need accounting services as well as services to establish a fair market value of the IP, both of which may be supplied by the network. One or more members of the network, such as accounting firms, may also provide auditing services to provide a confirmation of IP values to investors.

There are many advantages of the method described herein. First of all, the method provides “one-stop shopping” in a centralized, comprehensive marketplace that contains all the services needed to commercialize IP. This provides convenience and saves time and expense for the interested party (inventor, author, trademark owner, etc.) as compared to having to contact such parties individually, which is what an interested party typically has to do now. The formation of this network also better promotes the exchange of ideas, goods, and services and improves communication among the participants in the network. The network helps to create an identity for the IP industry, and increases public awareness and access to the members of this industry. The network can also serve as a governing body and policy formation body, and as an advocate or lobbying entity.

The network also provides mechanisms for assigning tangible rather than intangible value to IP assets, and may improve the overall quality of IP by providing access to expertise in all facets of IP protection and development. The network promotes education and understanding of the IP industry, and may make the business of IP more comprehensible to the public. The network may also provide avenues for improving the professional skills of its members through education, seminars and conferences, and may improve the R&D process overall through such education, awareness, and access to expertise. The network may also promote innovation through an awards and recognition program whereby members or inventive entities are recognized for innovation or expertise in bringing innovation to the marketplace. Through publications, the network may promote the IP industry generally, and the members of the network individually.

The method of this invention may also comprise the sub-method of providing a financial market for IP, such as through the issuance of securities for IP assets, or by creating a marketplace or auction service for the buying and selling of IP assets.

One aspect of the invention may comprise providing a comprehensive, centralized marketplace where the forces of supply and demand in the intellectual property field may be brought together under one roof. For example, such a marketplace may comprise a trade show organized with respect to the natural life cycle of commercialization of intellectual property. Thus, exhibitors at the trade show may be grouped in sections dealing with each of the stages of commercialization. For example, exhibitors relating to pre-prototype areas such as concept generation and sketching or flowcharting may be grouped together, prototype manufacturers and pre-production prototype manufacturers may be grouped together, and law firms or others (such as searchers, draftspeople, etc.) relating to activities needed to pursue, secure, and license IP rights may be grouped together. Still other groups may include service organizations that conduct product testing, commercial product manufacturers, consultants who can assist with pricing, market testing, advertising and marketing, or sale and distribution of the product, who may be grouped together or grouped separately by specific expertise, and organizations dealing with sale of the product business or bankruptcy. Investors, venture capitalists, and organizations that specialize in taking products from conception to market may also be represented. Government agencies such as the U.S. Patent and Trademark Office and Copyright Office may also be represented. Because of the international scope of IP in today's marketplace, another grouping may relate to international IP protection and commercialization. Additional groupings or subgroupings may relate to the specific type (i.e. patents, trademarks, copyrights, etc.) of intellectual property to be commercialized.

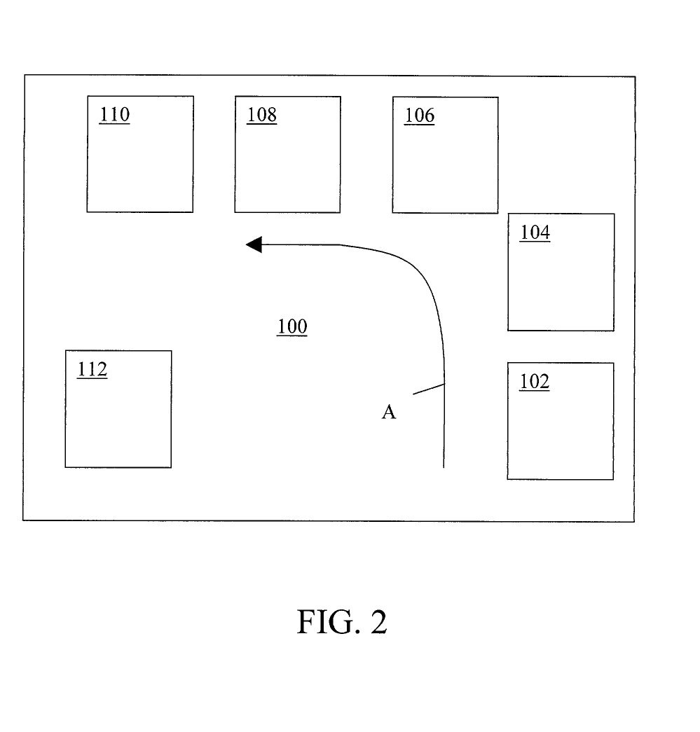

An exemplary set of groupings is shown in the schematic diagram of FIG. 2. FIG. 2 shows a plan view of an exemplary physical layout of a trade show floor 100 consistent with one aspect of the invention. Each labeled block corresponds to a service provider booth or group of service provider booths corresponding to one of the potential steps in commercializing intellectual property. For example, area 102 may be for legal service providers, including prior art search service providers; area 104 may be for business service providers, including investors and financiers as well as IP valuation and/or audit service providers; area 106 may be for pre-market service providers, including service providers in areas such as modeling, prototype manufacture, R&D (including contract R&D labs as well as services that analyze and/or evaluate existing R&D programs), and industrial design; area 108 may be for commercialization service providers, such as manufacturers, marketers, and licensing agents; area 110 may be for after-market service providers, such as insurance services, security analysis services; and management consulting services. It should be recognized that some services may fit within multiple areas. For example, IP valuation service may be useful both before commercialization and after commercialization, and thus such service providers may be in either corresponding area, or both. Government entities, such as the USPTO or Copyright office, may be represented in area 102, since they relate to the legal part of IP protection, or may be elsewhere in the layout. A special area 112 for inventors to display their ideas may also be present, which may include a dedicated marketplace for buying, selling, auctioning, and bidding on IP assets. Arrows A show the preferred flow of attendees through the show, which mimics the flow of IP through the commercialization process.

Another aspect of the invention is the creation of an educational and accreditation program for educating and accrediting Certified IP Analysts (CIPA). Such an educational program and professional accreditation, akin to similar programs for Certified Public Accountants, Certified Real Estate Appraisers, and the like, provides a vehicle for certifying professionals trained in assigning tangible values to heretofore intangible IP and in analyzing the impact of IP holdings on securities prices. Such a program requires education in a combination of accounting, financial, legal, and actuarial skills known in the art to individuals currently skilled in the practice of assigning tangible values to IP and securities analysis. Although various individuals practice in this growing area, there is no certification or accreditation that assures a consumer that the individual he or she has chosen is fully trained in the skills necessary to practice in this specialized field.

In still another aspect of the invention, pursuant to bringing together the forces of supply and demand, is the creation of the centralized, comprehensive marketplace that creates a mechanism whereby intangible assets can realize tangible value. That is, inventors with ideas coming to a trade show as described herein, may be afforded the opportunity to meet with investors, venture capitalists and potential licensees. The trade show may comprise a trading floor where IP assets or securities based upon IP assets may be bought and sold. For example, inventors or invention developers may pitch their ideas and investors may bid on supplying funds to those in need of equity or debt financing. Thus, in addition to being an information exchange, the trade show of the present invention may also comprise a financial exchange.

In yet another aspect of the invention, the network may comprise a governing body for the marketplace that organizes the IP industry into a comprehensible structure that organizes the industry. For example, each of the groupings of service providers relating to different aspects of IP commercialization in a physical layout of a trade show may further comprise sub-groupings of the network that set standards for similar organizations in the industry. The umbrella organization or network that runs the trade show may be a group that operates for profit or not for profit.

In one embodiment of the invention, the method may be carried out with respect to a global computer network. The term “global computer network” as used herein does not imply any particular geographic scope of the network or any specific network, but merely that the network is accessible by a number of users. The computer network may be local, national, or international, and may be open, or closed. For example, the network of service providers may have a common website on the Internet on which information about the various service providers may be accessed and through which individual providers may be contacted. For example, the website may be set up as a “virtual trade show” in which a screen resembling the trade show floor in FIG. 2 is used to access information corresponding to the various service providers. Thus, a user may click on a heading “legal service providers” and then be provided with a screen of subcategories comprising prior art search services, law firms, licensing firms, the USPTO and/or U.S. Copyright Office, and the like. After clicking a subcategory, the user may then be presented with a list of service providers in that subcategory. The website may further provide a searching subroutine where a prospect may use keywords to find, for example, service providers dealing with “prototypes.” The searching subroutine may further comprise a data entry form where the user can enter characterizing information about the user, such as but not limited to, the type of IP, the subject area of the IP (i.e. electronics, medical devices, etc.), and the geographic region of the user, so that the computer means operating the website can match the user to a service provider who is particularly well-suited for the user's needs.

Thus, a computerized aspect of the invention may comprise the steps of providing a dedicated site on the global computer network accessible by the interested party; providing computerized means for digitally receiving a request for information about one or more service provider members from the interested party; providing a database of records relating to the service provider members searchable by the computerized means in response to the request for information; and providing the requested information to the interested party.

Although described above with respect to access provided by means of a global computer network, a telephonic system may also or instead be provided, such as comprising a menu of choices from which the user may choose by pressing phone keys in response to prompts from the telephonic system. The technology for administering such telephonic systems is well known in the art.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed is

1. A method for commercialization of intellectual property (IP), the method comprising the steps of:
(a) providing a comprehensive, centralized network of service provider members, each member having expertise in at least one facet of IP commercialization;
(b) offering an interested party access to the network; and
(c) members of the network providing services to the interested party.

2. The method of claim 1 wherein the interested party has an interest in receiving information, data, or a combination thereof regarding at least one aspect of IP and the method further comprises the steps of:
(d) collecting data relating to at least said one aspect of IP; and
(e) disseminating said data to at least said interested party.

3. The method of claim 2 wherein the information comprises ranking information identifying, classifying, comparing, ranking and evaluating one or more IP assets, entities that own or control IP, or sources of IP, and the method further comprises compiling said ranking information.

4. The method of claim 3 further comprising using said ranking information to recognize innovation by presenting awards to top ranked entities.

5. The method of claim 1 wherein the interested party is also a member of the network.

6. The method of claim 1 wherein the members of the comprehensive network comprise inventors, government entities, research and development (R&D) and manufacturing entities, IP specialists, providers of business services, and IP marketplace providers.

7. The method of claim 1 wherein the services provided by the network comprise one or more services in the group consisting of: prior art search services; legal services; financial services; prototyping services; model making services; manufacturing; testing services; industrial design services; commercial art services; marketing services; IP valuation services for assigning tangible value to IP assets; IP audit services; services that provide R&D project analysis, evaluation, or both; insurance services, security analysis services; and management consulting services.

8. The method of claim 1 wherein the method further comprises creating a financial market for IP assets where IP assets, or securities based upon IP assets, can be bought and sold.

9. The method of claim 1 wherein the method further comprises providing a certification program for certifying IP analysts qualified to provide tangible valuation of IP assets.

10. The method of claim 1 wherein the method further comprises providing an educational program comprising education in accounting, financial, legal, and actuarial skills for educating individuals how to provide tangible valuation of IP assets.

11. The method of claim 1 wherein the method comprises providing a trade show in which a plurality of the service providers exhibit information to others about the services offered by the service providers.

12. The method of claim 11 wherein the facet of IP commercialization in which each member has expertise corresponds to a step in a natural life cycle of an IP asset, the trade show having a physical layout organized with the service providers grouped together according to step in the IP asset life cycle.

13. The method of claim 12 wherein the service providers are grouped into legal service providers, business service providers, pre-market service providers, commercialization service providers, and after-market service providers.

14. The method of claim 12 wherein the trade show includes a dedicated marketplace for buying, selling, auctioning, and bidding on IP assets.

15. A method for commercialization of intellectual property (IP), the method comprising the step of providing a trade show in which a comprehensive network of service providers exhibit information to others, each service provider having expertise corresponding to at least one step in a natural life cycle of an IP asset, in which the service providers are grouped in a physical layout at the trade show by association with a corresponding step in the IP asset life cycle.

16. The method of claim 15 wherein the service providers are grouped into legal service providers, business service providers, pre-market service providers, commercialization service providers, and after-market service providers

17. The method of claim 15 wherein the trade show includes a dedicated marketplace for buying, selling, auctioning, and bidding on IP assets.

18. The method of claim 1 wherein the access to the network is provided by means of a global computer network or by telephone.

19. The method of claim 18, wherein the access further comprises:
(b1) providing a dedicated site on the global computer network accessible by the interested party;
(b2) providing computerized means for digitally receiving a request for information about one or more service provider members from the interested party;
(b3) providing a database of records relating to the service provider members searchable by the computerized means in response to the request for information; and
(b3) providing the requested information to the interested party.

20. The method of claim 19, wherein step (b2) comprises receiving characterizing information pertaining to the interested party, and matching a service provider member to the interested party based upon the characterizing information.

21. The method of claim 20, wherein the characterizing information comprises information selected from the group consisting of: type of IP about which the interested party desires the information, subject area of the IP, and the geographic region of the interested party.
